(19) United States
(12) Patent Application Publication
(10) Pub. No.: US 2009/0285538 A1
(43) Pub. Date: Nov. 19, 2009

(54) HIGH COLLECTION EFFICIENCY FIBER OPTIC PROBES

(75) Inventor: Eric Marple, Laxahatchee, FL (US)

Correspondence Address: PATTON BOGGS LLP, 8484 WESTPARK DRIVE, SUITE 900, MCLEAN, VA, 22102, US

(73) Assignee: Prescient Medical, Inc., Doylestown, PA (US)

(21) Appl. No.: 12/466,930

(22) Filed: May 15, 2009

Related U.S. Application Data
(60) Provisional application No. 61/071,772, filed on May 16, 2008.

(51) Int. Cl. G02B 6/04; G01J 3/44

(52) U.S. Cl. 385/115; 356/301

(57) ABSTRACT

The invention provides miniature side-viewing fiber optic probes that achieve high collection efficiency by maximizing the overlap of a laser delivery fiber's illumination and a collection fiber's collection cone. The probes can be made with as few as one optical piece, in addition to the optical fibers. In one embodiment of the invention, the probes are configured for performing Raman spectroscopy. Spectroscopy systems utilizing the probes of the invention are also provided.

This application claims the benefit of U.S. Provisional Patent Application Ser. No. 61/071,772 filed May 16, 2008, which is hereby incorporated by reference herein in its entirety.

### FIELD OF THE INVENTION

The invention relates generally to optical fibers and fiber optic probes and more particularly to fiber optic probes for Raman spectroscopy.

### BACKGROUND OF INVENTION

U.S. Pat. No. 5,953,477 discloses methods and apparatuses for the manipulation and management of fiber optic light, and is incorporated by reference herein in its entirety.

U.S. Pat. No. 6,144,791 discloses the use of beam steering techniques in optical probes, and is incorporated by reference herein in its entirety.

U.S. Pat. No. 6,222,970 discloses methods and apparatuses for filtering optical fibers and applying filters to optical fibers, and is incorporated by reference herein in its entirety.

U.S. Pat. No. 6,445,939 discloses ultra-small optical probes, imaging optics and methods of using the same, and is incorporated by reference herein in its entirety.

U.S. Publication No. 20060139633 discloses methods and systems of high-wavenumber Raman spectroscopy for measuring tissue properties including for characterizing atherosclerotic plaques, and is incorporated by reference herein in its entirety.

### SUMMARY OF INVENTION

The present invention provides side/lateral-viewing fiber optic probes.

One embodiment of the invention provides a fiber optic probe that includes:

a laser delivery optical fiber comprising a central axis, a proximal end and a distal end that comprises a distal face at least substantially normal to the central axis of the laser delivery optical fiber;

a light collection optical fiber comprising a central axis, a proximal end and a distal end that comprises a distal face that is normal or angled with respect to the central axis of the light collection optical fiber; and

an optical piece operably connected to the laser delivery optical fiber, the optical piece comprising a first face configured to receive laser light into the piece from the distal end of the laser delivery optical fiber, a second face adjacent to the first face and configured to reflect light from the laser delivery fiber in an off-axis direction toward and through the distal end of the light collection fiber to illuminate a sample, and a third face opposite the second face and configured to reflect light received back from the sample into the light collection optical fiber toward its proximal end,

where the distal face of the light collection optical fiber is angled with respect to its central axis and connected to the third face of the optical piece, or the distal face of the light collection fiber is normal with respect to its central axis and the probe further comprises an optical spacer between said distal face and the third face of the optical piece, and where the central axes of the laser delivery optical fiber and the light collection optical fiber are at least substantially parallel to each other at the distal ends of the fibers.

The distal face of the light collection optical fiber may be angled at or about 45-degrees with respect to the central axis of the light collection optical fiber and joined to the third face of the optical piece. In one variation, the distal face of the light collection optical fiber is angled with respect to the central axis, the first face of the optical piece is joined to the distal face of the laser delivery optical fiber, the third face of the optical piece is joined to the distal face of the light collection optical fiber, and the second and third face of the optical piece and the distal face of the optical collection fiber are at least substantially parallel to each other.

In another variation, the distal face of the light collection optical fiber is angled with respect to the central axis, the first face of the optical piece is joined to the distal face of the laser delivery optical fiber, the third face of the optical piece is joined to the distal face of the light collection optical fiber, and the second and third face of the optical piece and the distal face of the optical collection fiber are at least substantially parallel to each other.

The second face of the optical piece may include a mirror or long wavelength pass filter. The third face of the optical piece may include a short wavelength pass filter. The third face of the optical piece may include a short wavelength pass filter. The optical piece may have the profile of a parallelogram. The optical piece may be a parallelepiped.

Another embodiment of the invention provides a fiber optic Raman spectroscopy probe, that includes:

a laser delivery optical fiber for delivering laser light comprising a central axis, a proximal end and a distal end that comprises a distal face at least substantially normal to the central axis of the laser delivery optical fiber;

a light collection optical fiber comprising a central axis, a proximal end and a distal end that comprises a distal face a distal face at least substantially normal to the central axis of the laser delivery optical fiber,

wherein the central axes of the laser delivery optical fiber and the light collection optical fiber are at least substantially parallel to each other at the distal ends of the fibers; and

a composite optical piece having a proximal surface facing the distal end faces of the optical fibers, said surface disposed at an angle with respect to the central axes of the optical fibers, the composite optical piece comprising:
a proximal first filter layer within the optical field of the laser delivery fiber and the light collection fiber wherein the first filter layer is a short wavelength pass filter selected to transmit the laser light and reflect Raman scattered light received from a sample, and
a distal second filter layer at least substantially restricted the optical field of the laser delivery fiber wherein the second filter layer is a long wavelength pass filter or mirror selected to reflect laser light from the laser delivery fiber.

The proximal surface of the composite optical piece may be disposed at or about a 45-degree angle with respect to the central axes of the optical fibers. The probe may include an optical spacer disposed between the distal end faces of the optical fibers and the optical piece. A short wavelength pass filter selected to reflect Raman scattered light arising from the light delivery optical fiber may be disposed on the distal end of the laser delivery fiber.

Another embodiment of the invention provides a fiber optic Raman spectroscopy probe that includes:

a laser delivery optical fiber for delivering laser light comprising a central axis, a proximal end and a distal end that comprises a distal face at least substantially normal to the central axis of the laser delivery optical fiber;

a light collection optical fiber comprising a central axis, a proximal end and a distal end that comprises a distal face a distal face at least substantially normal to the central axis of the laser delivery optical fiber,

wherein the central axes of the laser delivery optical fiber and the light collection optical fiber are at least substantially parallel to each other at the distal ends of the fibers; and

a composite optical piece having a proximal surface facing the distal end faces of the optical fibers, said surface disposed at or about a 45-degree angle with respect to the central axes of the optical fibers, the composite optical piece comprising:
a proximal first filter layer comprising:
   a first section at least substantially restricted to the optical field of the laser delivery fiber, said first section being at least substantially transparent to the laser light, and
   a second section at least substantially restricted to the optical collection filed of the light collection fiber, wherein said second section is a short wavelength pass filter selected to transmit the laser light and reflect Raman scattered light received from a sample; and
a distal second filter layer at least substantially restricted the optical field of the laser delivery fiber wherein the second filter layer is a long wavelength pass filter selected to reflect laser light from the laser delivery fiber and transmit Raman scattered light arising from the light delivery fiber.

The probe may further include an optical spacer disposed between the distal end faces of the optical fibers and the composite optical piece.

Another embodiment of the invention provides a fiber optic probe that includes:

a laser delivery optical fiber comprising a central axis, a proximal end and a distal end that comprises a distal face at least substantially normal or angled with respect to the central axis of the laser delivery optical fiber;

a light collection optical fiber comprising a central axis, a proximal end and a distal end that comprises a distal face that is normal with respect to the central axis of the light collection optical fiber;

an optical piece operably connected to the light collection optical fiber, the optical piece comprising a first face joined to the distal end of the light collection fiber, a second face adjacent to the first face and configured to reflect light received into the optical piece from a sample toward and into the collection fiber, and a third face opposite the second face,

wherein the distal face of the laser delivery optical fiber is angled with respect to its central axis and connected to the third face of the optical piece, or the distal face of the laser delivery fiber is normal with respect to its central axis and the probe further comprises an optical spacer between said distal face and the third face of the optical piece, said spacer comprising an angled face connected to the third face of the optical piece, and

wherein the central axes of the laser delivery optical fiber and the light collection optical fiber are at least substantially parallel to each other at the distal ends of the fibers.

The second face of the optical piece may include a mirror, a band-pass filter or a short-pass filter selected to reflect light received into the optical piece through its third face toward and into the light collection fiber. The third face of the optical piece may include a long pass filter selected to reflect laser light from the delivery fiber out of the probe to illuminate a sample while passing wavenumber-shifted light returning from the sample into the optical piece. The angled face of the light delivery optical fiber or the optical spacer may include a long pass filter selected to reflect laser light from the delivery fiber out of the probe to illuminate a sample while passing wavenumber-shifted light returning from the sample into the optical piece. The optical piece may have the profile of a parallelogram. The optical piece may be a parallelepiped.

The invention also provides a Raman spectroscopy system that includes: at least one fiber optic probe as described herein; a laser operably connected to the delivery fiber of the probe; and a spectrometer operably connected to the collection fiber of the probe. In one variation, the system is configured to perform fingerprint region Raman spectroscopy. In another variation, the system is configured to perform fingerprint region Raman spectroscopy and/or high wavenumber Raman spectroscopy. In a related variation, the system is configured to simultaneously perform fingerprint region Raman spectroscopy and high wavenumber Raman spectroscopy. The laser of the system may, for example, be a near-infrared laser.

Additional features, advantages, and embodiments of the invention may be set forth or apparent from consideration of the following detailed description, drawings, and claims. Moreover, it is to be understood that both the foregoing summary of the invention and the following detailed description are exemplary and intended to provide further explanation without limiting the scope of the invention as claimed.

### BRIEF DESCRIPTION OF THE DRAWINGS

FIG. 1. illustrates an embodiment of an optical probe according to the invention.

FIG. 2. illustrates an embodiment of an optical probe according to the invention.

FIG. 3. illustrates an embodiment of an optical probe according to the invention.

FIG. 4. illustrates an embodiment of an optical probe according to the invention.

FIG. 5. illustrates an embodiment of an optical probe according to the invention.

FIG. 6 illustrates an embodiment of an optical probe according to the invention.

FIG. 7 illustrates an embodiment of an optical probe according to the invention.

FIG. 8 illustrates an embodiment of a manufacturing process for the optical piece of a probe according to the invention.

FIG. 9 illustrates a basket catheter embodiment of the invention.

FIG. 10 illustrates a system embodiment of the invention in which optical probes according to the invention are presented by a basket-style intravascular catheter.

### DETAILED DESCRIPTION

The present invention provides side/lateral-viewing fiber optic probes and methods for their manufacture.

The probes of the invention achieve high collection efficiency by maximizing the overlap of a laser delivery fiber's illumination and a collection fiber's collection cone. This design also minimizes the silica fiber Raman signature produced. This is achieved by providing that the optical axis of both fibers is similar or the same. This allows a very small probe to be manufactured since only two fibers are needed. The diameter of the fibers may be at least substantially the same or the two fiber sizes can be varied to achieve the best performance. Overlap of the optical paths of two fibers has been done previously with expanded beam/conventional optics, but expanded beam optics need air interfaces, are very large in size, and are costly. One of the advantages of this new design is that the probe can be made with as few as one optical piece, other than the optical fibers, such as a rhomboid with a filter coated on one face and a mirror on the opposite face. The optical filters/pieces may be made in large numbers inexpensively by partially machining these pieces prior to coating, and then completing the machining after the filter coating. In this manner, many precise components can be inexpensively manufactured. These components may, for example, be placed manually or by standard pick and place techniques developed for diode laser manufacturing to produce probes quickly and efficiently.

As used herein, “rhomboid” is synonymous with parallelepiped and means a solid figure with six faces in which each face is a parallelogram and opposite faces lie in parallel planes.

Various aspects and embodiments of the invention are further described below with referenced to the accompanying figures.

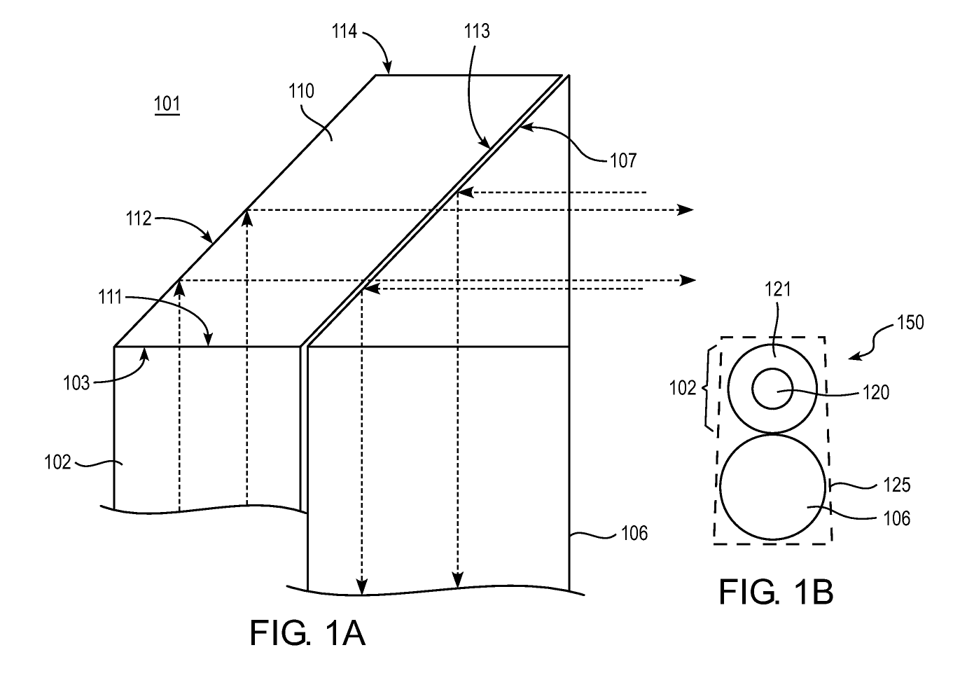

FIG. 1 illustrates an embodiment of an optical probe 101 according to the invention. A laser delivery optical fiber 102 and a light collection optical fiber 106 are provided so that their longitudinal optical axes are aligned, at least at or near their distal ends (as shown). Laser delivery fiber 102 has a distal end face 103 that is normal to the longitudinal axis of the fiber. Light collection fiber 106 has a distal end face 107 that is at a 45-degree angle to the longitudinal axis of the fiber. End face 107 may, for example, be a polished end face of the fiber. Optical piece 110 is operably connected to laser delivery fiber 102 and light collection fiber 106. Optical piece 110 has the following faces: a first face 111 parallel with end face 103, through which laser light is received from light delivery fiber 102; a second face 112 at a 45-degree angle to the aligned optical axes of the fibers to reflect light received from light delivery fiber 102 in a lateral direction toward and through light collection fiber 106 to illuminate a sample; and a third face 113 that reflects light received back from a sample as a result of its illumination down light collection optical fiber 106 for analysis. The optical piece also has a fourth face 114 which does not play a functional role in the optics of the probe of this embodiment.

A top distal end view 150 of the probe is also shown. In the embodiment shown, laser deliver fiber 102 consists of an inner optical fiber component 120 and an outer spacer tube component 121. The diameter of light collection optical fiber 106 is greater than that of the inner optical fiber component 120 of the laser delivery fiber 102. Dashed line 125 represents the profile of optical piece 110 as viewed from the end of the probe. In the embodiment shown, in view 150, optical piece 110 has a rectangular shape and the piece as a whole is a rhomboid. However, the probes of the invention are not so-limited. Instead, it should be readily appreciated that what is important for the functioning of the optical piece is the relative configuration of the face of the optical piece meeting the end face 103 of the laser delivery fiber, the adjacent face of the optical piece that reflects light toward the sample, and the adjacent face 113 that reflects light received from the sample down light collection fiber 106. Thus, face 114 need not be planar or parallel to face 111 and profile 125 need not be rectangular.

Face 112 of the optical piece may, for example, be coated or have placed thereon a mirror or long wavelength pass filter to reflect laser light toward a sample. Face 113 of the optical piece may be coated with or have placed thereon a short wavelength pass filter to pass laser light directed toward the sample and reflect light having wavelengths of interest for analysis into the light collection fiber for analysis. Alternatively, face 107 may be coated with or have placed thereon a short wavelength pass filter to serve the same purpose, but use of face 113 is preferred. Other types of filters, such as band-pass filters, could also be used (on face 113 or face 107). Where the probe is a probe for Raman spectroscopy, face 113 (or face 107) may, for example, be coated with, have applied thereon or otherwise include a pass filter to pass laser light directed toward the sample and reflect Raman scattered light from the sample, within a wavenumber range of interest for analysis, toward the collection fiber.

It should be understood that the terms “long wavelength pass” and “short wavelength pass” as used herein in connection with optical components are relative to the emission wavelength of the light source, i.e., the laser, used. For example, in a Raman spectroscopy embodiment utilizing a 785 nm emission laser, a long wavelength pass filter blocking 785 nm and shorter wavelength light, while passing wavelengths longer than 785 nm, for example upt to at least 1100 nm could be used. In this case, the short wavelength pass filter would pass the 785 nm laser light and shorter wavelengths, while rejecting wavelengths longer than 785 nm up to at least 1100 nm.

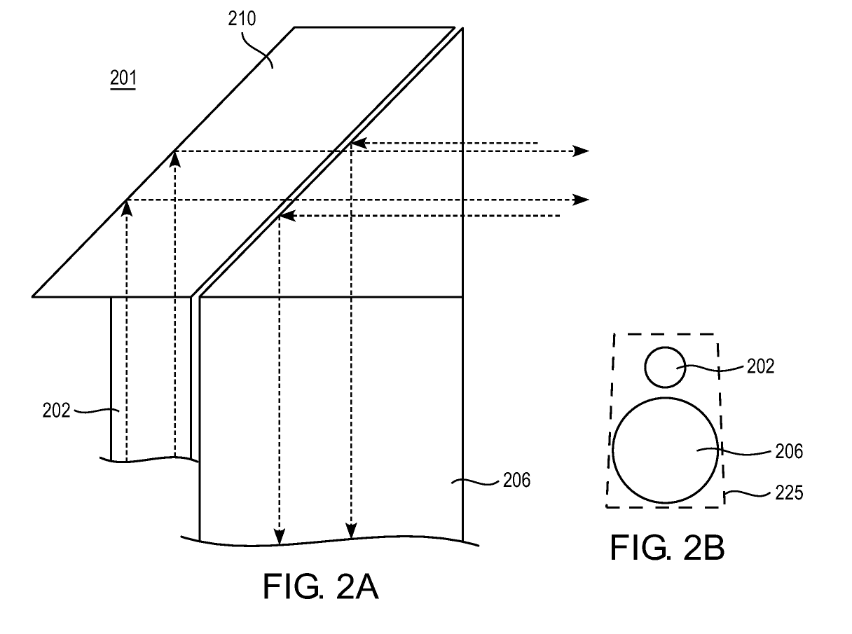

FIG. 2 shows an embodiment of an optical probe 201 similar to that shown in FIG. 1 with its elements similarly numbered but where laser delivery fiber 202 is not surrounded by a spacer tube. In the embodiment shown, the side wall of laser delivery fiber 202 is juxtaposed to the side wall of light collection fiber 206. Laser delivery fiber 202 is of a smaller dimension than collection fiber 206 and fiber 202 is disposed with respect to optical piece 210 so that the cone of light emitted from fiber 202 travels a path that results in good or optimized collection of light with respect to the collection cone of collection fiber 206. Stated another way, by properly positioning a smaller delivery fiber, the overlap of a laser delivery fiber's illumination and a collection fiber's collection cone can be optimized. For a given diameter and position of the delivery fiber, it should also be appreciated that the thickness of optical piece 210 (corresponding to the distance between faces 112 and 113 in FIG. 1) can also be selected to obtain a desired or optimized overlap between the delivery fiber's illumination and a collection fiber's collection cone.

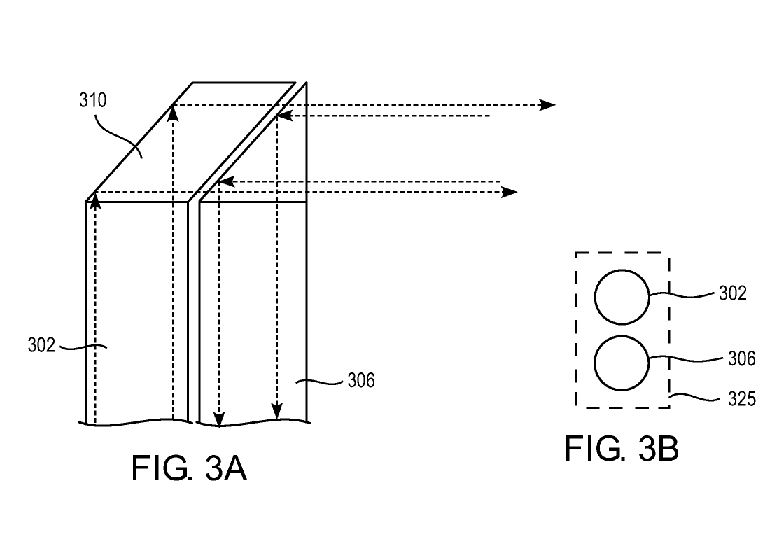

FIG. 3 shows an embodiment of an optical probe 301 similar to that shown in FIGS. 1 and 2 with its elements similarly numbered but where laser delivery fiber 302 and light collection optical fiber 306 have similar or the same diameters. Laser delivery fiber 302 is not disposed with a spacer tube and its side wall is juxtaposed to that of light collection fiber 306.

FIGS. 1-3 show partially exploded views of the various embodiments described, with the gaps shown not present in the assembled state. However, embodiments with gaps between one or more of the components shown are also provided by and within the scope of the invention and one or more of such gaps may be occupied by spacers, such as optically transparent spacing elements in the case where light must pass through a spacer in the operation of the embodiment.

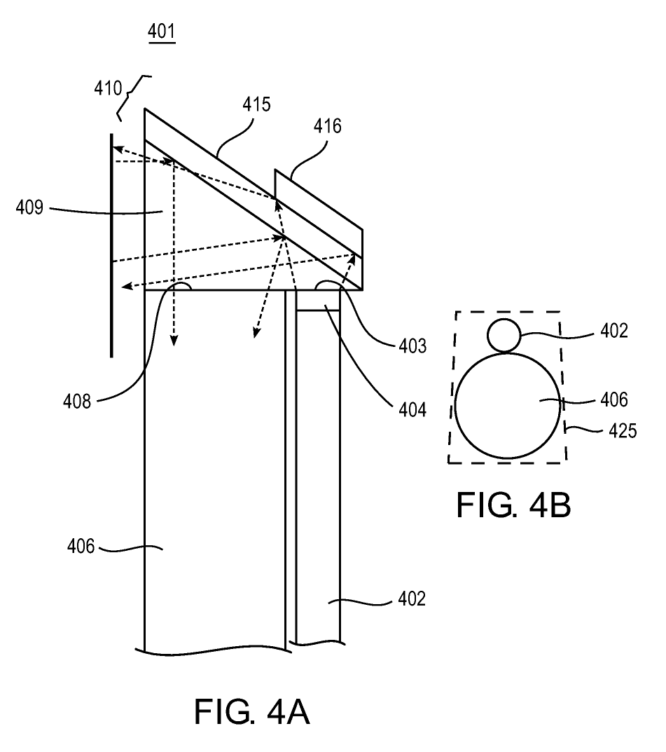

FIG. 4 shows an embodiment of an optical probe 401 according to the invention that is designed for performing Raman spectroscopy and includes a composite optical piece 410. Probe 401 includes a laser delivery optical fiber 402 having a short wavelength pass filter 404 at its distal end that presents the distal face 403 of the fiber, which is normal to the longitudinal axis of fiber 402. Short wavelength pass filter 404 is selected to pass laser excitation from the fiber and reflect silica Raman scattered light from fiber 402 (back into the fiber). A light collection optical fiber 406 is provided having a distal end face 408 that is, in this embodiment, coplanar with end face 403 of laser delivery fiber 402. The longitudinal axes of fiber 406 and fiber 402 are coaligned, at least near their distal ends, as shown. A transparent optical spacer 409 having a triangular profile is disposed between the ends faces of the fibers and composite optical piece 410. The optical spacer 409 provides a diagonal surface for mounting composite optical piece 410 so that light from laser delivery fiber 402 can be redirected laterally and light received from a sample can be directed down light collection optical fiber 406 for analysis. Composite optical piece 410 includes a first layer 415 which has the properties of a short wavelength pass filter to pass laser light from the excitation source and reflect Raman scatter light from the sample into light collection fiber 406. Composite optical piece 410 also includes a second layer 416 which has the properties of a long wavelength pass filter or a mirror to redirect laser light from laser delivery fiber 402 laterally toward a sample. As shown in the figure, layer 416 is not longitudinally coextensive with layer 415. Instead, layer 416 is disposed only in the field of laser delivery fiber 402. In this manner, layer 415 can reflect Raman scattered light from a sample into light collection fiber 406 while excitation light reflected back from the sample exits the probe through layer 415 rather than being reflected into light collection fiber 406. The part of the top surface of layer 415 that is not covered by layer 416 may, for example, be covered by nothing, be covered by a transparent material, or be covered by a light trapping (“beam dump”) material. Similarly, the top surface of layer 416 may, for example, be covered by nothing, be covered by a transparent material, or be covered by a light trapping (“beam dump”) material. With reference to component 410, the thickness of the filter mirror substrate can be selected so that reflection of laser light from laser delivery fiber 402 will illuminate a desired area to maximize the collection efficiency of the Raman scattered light. Thus, the thickness of the flat mirror substrate may be selected to ensure that the illumination beam overlaps with (is centered in) the collection beam.

A top view 450 of the probe is also shown. In the particular embodiment shown, laser delivery fiber 402 has about ⅓ the diameter of light collection fiber 406. An outline 425 of the profile of optical piece 410 is also shown.

The probe may also include, if desired, a long wavelength pass filter at the distal end of light collection optical fiber 406.

In another variation, the probe may include a small lens at the distal end of laser delivery fiber 102 for collimation.

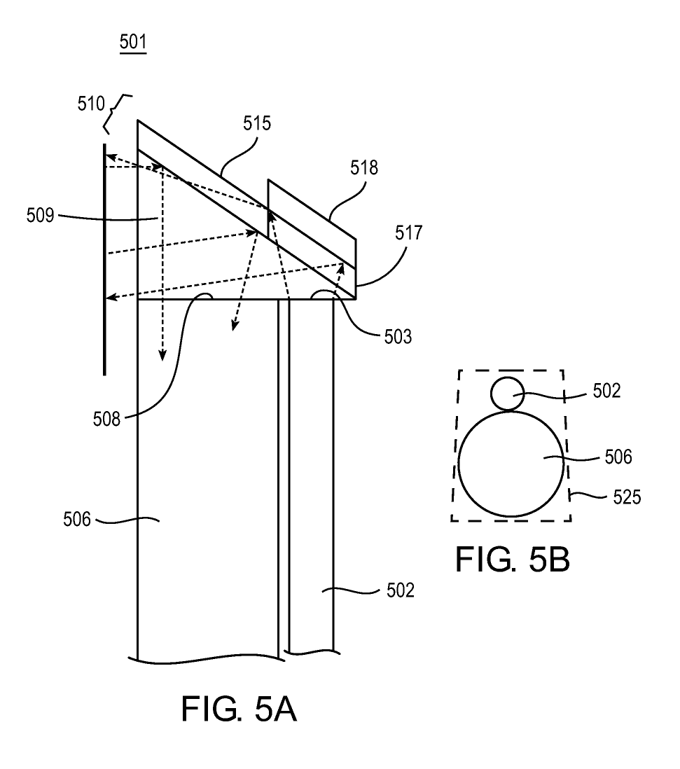

FIG. 5 shows another embodiment of a fiber optic probe 501 for performing Raman spectroscopy that includes a composite optical piece 510. Probe 501 includes a laser delivery optical fiber 502 having a distal face 503 of the fiber, which is normal to the longitudinal axis of fiber 502. A light collection optical fiber 506 is provided having a distal end face 508 that is, in this embodiment, coplanar with end face 503 of laser delivery fiber 502. The longitudinal axes of fiber 506 and fiber 502 are coaligned, at least near their distal ends, as shown. A transparent optical spacer 509 having a triangular profile is disposed between the ends faces of the fibers and a composite optical piece 510. The optical space provides a diagonal surface for mounting of composite optical piece 510 so that light from laser delivery fiber 502 can be redirected laterally (off-axis) and light received from a sample can be directed down light collection optical fiber 506 for analysis. In an alternative embodiment, instead of optical spacer 509, a diagonal surface for mounting optical piece 510 is formed by polishing or otherwise shaping fibers 502 and 506 so that they co-angularly present a diagonal oriented surface for mounting optical piece 510.

Composite optical piece 510 includes a first layer section 515 which has the properties of a short wavelength pass filter to pass laser light from the excitation source and reflect Raman scattered light from the sample into light collection fiber 506. Coplanar with layer section 515 is a second layer section 517 that is transparent and which is in the field of laser delivery fiber 502. On top of layer section 517 is a third layer section 518 that has the properties of a long wavelength pass filter to reflect laser light (from laser deliver fiber 502, passed through layer 517) laterally toward a sample and pass silica Raman scattered light (from Raman scattering by fiber 502). This configuration allows proper overlap of the illumination and collection beams. Distally beyond (on top of) the layer sections shown may, for example, be nothing or transparent material and/or light-trapping material, as similarly described for the embodiment of FIG. 4.

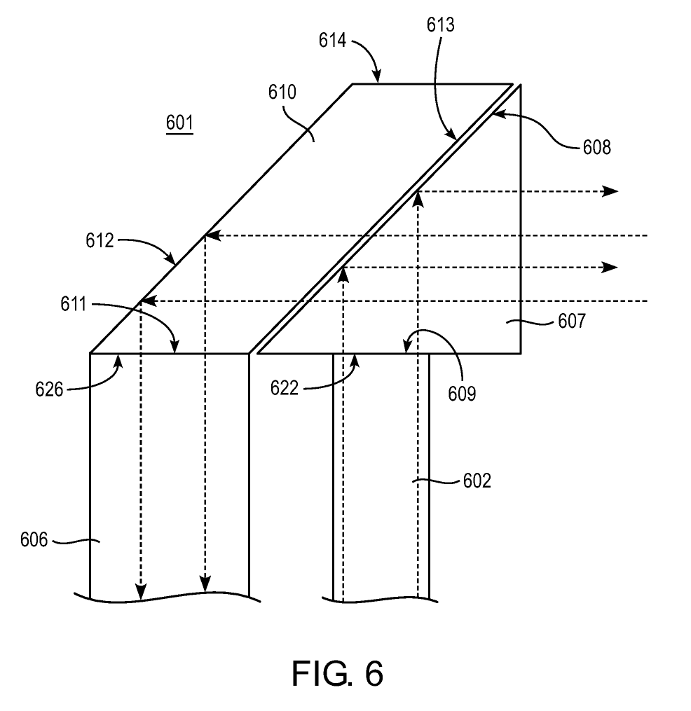

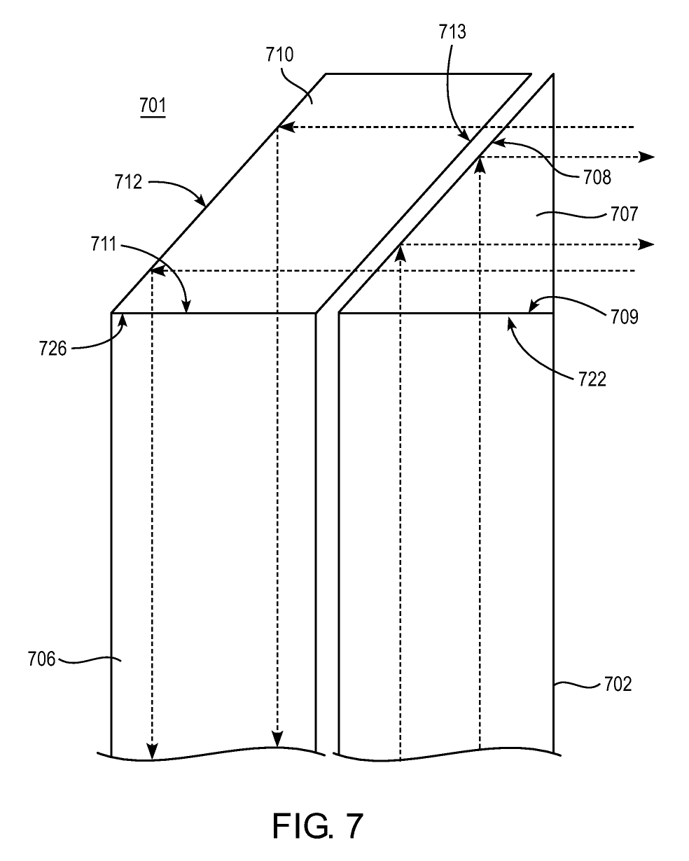

The invention also provides miniature optical probes having reverse configurations to those of the aforementioned embodiments. For example, FIG. 6 shows an optical probe embodiment of the invention that is a reverse configuration as the embodiment shown in FIG. 2. In FIG. 6, laser delivery fiber 602, is disposed in optical communication below triangular profile optical piece 607. Surface 608 of piece 607 or surface 613 of piece 610 comprises a long pass filter so that laser light from the delivery fiber is reflected out of the probe while wavenumber-shifted light returning from a target/sample will pass through optical piece 607 into trapezoidal profile optical piece 610. Surface 612 of optical piece 610 may be a mirror, band-pass filter or short-pass filter so that wavenumber-shifted light received into piece 610 is reflected into collection optical fiber 606. Base surface 611 of piece 610 is in contact with distal surface 626 of collection fiber 606. Base surface 609 of piece 607 is in contact with distal surface 622 of delivery fiber 602. As shown in the present figure, laser delivery fiber 602 is of a smaller diameter than collection fiber 606. Optionally, delivery fiber 602 may be provided with an annular spacer (spacer tube) or cladding to increase it overall diameter. In this case, the overall diameter of the delivery fiber (including spacer or cladding) may, for example, be the same or approximately the same as the width of the base (of the profile shown) of optical piece 607. Such an embodiment is shown in FIG. 7, the elements of which are similarly numbered as in FIG. 6.

The invention also provides a related, alternative embodiment in which the laser delivery fiber is a large clad fiber of sufficient diameter so that the distal fiber end can be angle polished to fit directly against surface/face 613 in FIG. 6 (or 713 in FIG. 7) of optical piece 610 in FIG. 6 (or 710 in FIG. 7), thereby eliminating the need for separate optical piece 607 in FIG. 6 (or 707 in FIG. 7). In this alternative embodiment, the angle polished surface/face of the delivery fiber takes the place of surface/face 608 of piece 607 in FIG. 6 (or corresponding surface/face 708 of piece 707 in FIG. 7).

The components of the optical assemblies of the invention may, for example, be joined to each other using UV epoxy and/or standard epoxy, such as those known in the art. Low fluorescence epoxies are particularly desirable for joining components so that optical interference is minimized during use.

The optical pieces 110, 210 and 310 of FIGS. 1-3 may, for example, be formed from glass, quartz or other optical materials that are coated with the described coatings.

Composite optical pieces such as those 410 and 510 of FIGS. 4 and 5 respectively may, for example, be formed using micromachining and/or photolithographic techniques adapted from the microchip manufacturing field.

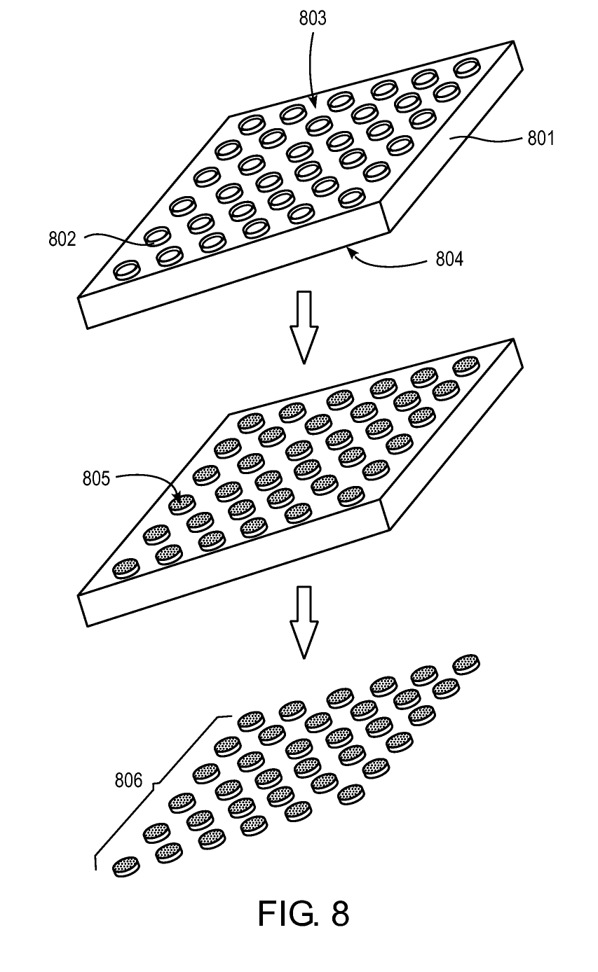

FIG. 8 illustrates a method for manufacturing optical pieces for optical probes according to the invention. A substrate 801 is provided that includes raised wells 802 extending to a preselected height above the surface of the substrate. The shape of the wells defines the shape of the optical piece to be formed. Here, wells 802 are tubular. The wells may, for example, be formed by laser machining and/or other types of machining of the substrate. Next, the substrate is coated with a filter material which is deposited on the machined surface of the substrate as shown in 805. Next, the coated substrate is thinned by removing material from its back side 804 (side opposite that having the well openings, i.e., opposite side 803), for example, by polishing, to the level of the base of the machined wells, thereby releasing the multiple individual optical pieces 806. Multiple filters/coating types may also be formed. For example, after the substrate is coated with filter material as shown in 805, a different filter material may be selectively spatially deposited using a photolithographic technique. Thus, the coated substrate may have a second filter material deposited on the first filter layer of filter material and so on. Although circularly shaped components are shown, it should be appreciated that the same methods may be used to produce optical pieces and layers thereof having any shape.

The filter substrate may, for example, be composed of fused silica. After the one or more filter coatings are deposited as desired, the filter coated substrate can first be securably placed on a plate with the filter side 803 down on the plate, using a wax or epoxy as a temporary adhesive. Then the filter coated substrate is polished thinner (from the backside 804) to the desired thickness. Then, the remaining wax or epoxy can be removed by chemical treatment, solvent, or by melting to release the individual pieces.

An example of a method for manufacturing the embodiment shown in FIG. 1 is now described for the purposes of further illustration. A 200 micron core collection fiber 106 is polished at 45 degrees as a bare fiber, such as by methods known in the art. The buffer of this fiber is removed from the fiber by thermal, chemical, or other means from the angled portion, so that approximately 0.25 inches in length of buffer is removed.

A 100 micron core laser delivery fiber has its buffer removed from the fiber by thermal, chemical, or other means so that approximately 0.25 inches in length of buffer is removed. A needle tube approximately 0.25 inches long is epoxied over the end of the 100 micron fiber with its buffer removed. The epoxy is cured and the assembly is polished, such as by methods known in the art. The needle tube also acts as a light block and minimizes crosstalk between the two optical fibers.

The use of a 200 micron collection fiber and a 100 micron delivery fiber advantageously provides for a very compact probe, however, it should be understood that the invention is not limited to any particular sizes of optical fibers.

Filter component optical piece 110 may be manufactured by first coating a fused silica flat of the proper thickness with a short wave pass filter designed for the wavelengths of interest on one side, and a mirror coating or long wave pass filter on the other side. Hard coat refractory oxide (e.g. silicon dioxide, titanium dioxide, tantalum pentaoxide) interference filters are best, but others may also be used in accordance with the invention. This coated flat is now diced (at the proper angle) into long bars (which will ultimately be diced into the individual components, e.g, using a diamond-coated circular dicing saw). This bar is polished on face 111 to an optical quality finish. Multiple bars can be placed together and polished at the same time if desired. These bars can now be diced into the proper dimension so that each individual chip is of the appropriate size. A jig may be used to facilitate processing of the bar into finished pieces.

Face 113 of optical piece 110) is placed on (joined to) fiber angled end face 107 of collection fiber 106. A small drop of optical UV epoxy is placed on the interface (preferably low fluorescence epoxy is used to minimize interference with the Raman signal during use) to join the two faces. Fiber in ferrule 102 is butted up to filter component optical piece 110 with a small drop of UV optical epoxy. This assembly is aligned and illuminated with UV light to cure the assembly together. Additional epoxy may be applied to other parts of the assembly to hold the assembly together if needed.

The distal assembly may have a needle tube (with cut-out window) placed and epoxied over the whole assembly if needed or desired to add strength to the assembly.

Flexible tubing may be placed over the optical fibers for protection and/or other materials needed for the desired application which run back to the proximal end of the probe. Any suitable type of tubing may be used, such as polyimide tubing or nylon tubing. A connector is placed at the proximal end of the probe over the optical fibers to mediate launching light into and receiving light from the probe.

Methods for coating substrates with interference filters, such as refractory oxide filters, and with optical materials generally, are well known in the art. High energy deposition techniques that may be used include magnetron sputtering, ion-assisted deposition, and ion beam sputtering techniques.

While the aforementioned examples all relate to side-viewing optical probes, it is possible and within the scope of the present invention to make front-viewing probes by changing the filter selection to alter the light path.

One embodiment of the invention provides a spectroscopy system (apparatus) that includes a fiber optic probe as described herein that includes an excitation (delivery) fiber and a collection fiber, a light source such as a laser in optical communication with the excitation fiber and a spectrometer or other light measuring device in optical communication with the collection fiber to analyze light returned from a target. It should be understood that any such system according to the invention may also include at least one controller to control the various components of the system such as the laser and the spectrometer and any shutters that may be associated therewith. The system may also include a computer which may include or work in conjunction with the controller. The computer may be operably linked to the spectrometer to record and/or process data obtained by the spectrometer, for example to provide a clinical indication such as a diagnosis of health or disease of a biological tissue or to provide an indication of the constituents of a sample generally. The system may also include a user interface by which a user may enter commands and/or a display or other output to display or otherwise provide data and/or results reflecting or obtained using the measurements taken by the spectrometer.

A related embodiment provides a Raman spectroscopy system (apparatus) that includes a fiber optic probe as described herein that includes an excitation (delivery) fiber and a collection fiber, a light source such as a laser in optical communication with the excitation fiber and a Raman spectrometer in optical communication with the collection fiber to analyze light returned from a target. Such a system may also include the other components mentioned above.

In one variation, the system including its probe is configured to perform Raman spectroscopy in the fingerprint region, i.e., 200-2,500 cm⁻¹, such as within the range 400-2,500 cm⁻¹. Analysis of Raman scattered light in the fingerprint region has been found to provide useful information for evaluation of health and disease states of biological tissue, such as vascular tissue, such as artery walls. Basic design considerations for Raman spectroscopy fiber optic probes are discussed in Motz et al. (2004) Optical Fiber Probe for Biomedical Raman Spectroscopy, Applied Optics 43(3): 542-554, which is incorporated by reference herein in its entirety. For fingerprint region Raman spectroscopy, delivery fiber(s) may be terminated with a short-wavelength-pass or a bandpass filter that transmits the laser excitation light while blocking the longer-wavelength spectral background from the fibers. The collection fiber(s) may be preceded by a long wavelength-pass filter or notch filter, which transmits the sample's Raman spectrum while blocking laser light backscattered from the tissue. Such filtering may be obtained in the manner disclosed for the fiber probes described hereinabove.

Any suitable type of laser source may be used in the fingerprint region Raman spectroscopy system. For example, a laser emitting in the near infrared (near-IR; NIR) wavelength region, such as at or around 785 nm for fingerprint region measurements may be used. One suitable laser is a spectrum stabilized 785 nm Laser P/N#: 10785SL0080PA from Innovative Photonics Solutions (Monmouth Junction, N.J., USA).

Similarly, any suitable type of Raman spectrometer may be used with the Raman spectroscopy embodiments such as the fingerprint region Raman spectroscopy embodiments. For example, for fingerprint region Raman spectroscopy with excitation at 785 nm, a HPRM2500 High Performance Raman Module spectrograph from River Diagnostics (Rotterdam, The Netherlands) and an InDus CCD: e2V CCD40-11. 1024×125, 26 mm² CCD camera from Andor (South Windsor, Conn., USA) may be used. Typical CCD detection arrays have sensitivity to wavelengths in the range of 300 nm to 1100 nm. Specialty CCD detection arrays having wider ranges of sensitivity may also be used.

Still another embodiment of the invention provides a Raman spectroscopy system including a probe according to the invention, which system is configured to perform both fingerprint region Raman spectroscopy and high wavenumber Raman spectroscopy, i.e., within the high wavenumber region 2,500-4,000 cm⁻¹, such as in the range 2,500-3,700 cm⁻¹. For example, by utilizing an excitation wavelength at or about 650 nm (delivered by the delivery fiber), fingerprint region and high wavenumber region Raman scattered light can be simultaneously collected by the collection fiber of a probe of the invention and simultaneously detected/measured by the spectrometer, such as a spectrometer utilizing a CCD array having a sensitivity in the range of 300 nm to 1100 nm. Thus, the system may be configured to simultaneously perform fingerprint region Raman spectroscopy and high wavenumber Raman spectroscopy using a probe according to the invention. A system embodiment including a probe according to the invention that alternates between, cycles between or switches between or is capable of being switched between fingerprint region Raman spectroscopy and high wavenumber Raman spectroscopy is also provided.

Another embodiment of the invention provides catheters such as intravascular catheters that include one or more of the fiber optic probes describes herein. The catheter may be a multi-channel catheter including at least two fiber optic probes describes herein wherein each fiber optic probe is associated with a different channel and has a different field of view. For an intravascular catheter, the fields of view of the fiber optic probes may, for example, be radially separated (but not necessarily mutually exclusive) at a longitudinal distal location along the catheter to permit a radial (at least partial) examination of a blood vessel at a single location.

The systems of the present invention may include side/lateral-viewing “basket-style” catheters in which the optical probes for interrogating the walls of blood vessel lumens are disposed on/in rods (probe arms) that can be flexed outward toward a blood vessel wall. In one embodiment, at least one of the probe arms includes a fiber optic probe as described herein, which directly or indirectly extends to the proximal end of the catheter for optical communication with a laser source and a spectrometer. By “indirectly extends to the proximal end of the catheter” it is meant that the actual fiber segment attached to the distal end of the probe need not extend all the way to the proximal end of the catheter but may, instead, for example, be connected (optically) to a separate optical fiber at some point, which separate fiber then continues to the proximal end of the catheter. In one variation, at least two probe arms include a fiber optic probe of the invention, which directly or indirectly extends to the proximal end of the catheter for optical communication with a laser source and a spectrometer. In still another variation, all of the probe arms of the basket catheter include a fiber optic probe of the invention, which directly or indirectly extends to the proximal end of the catheter for optical communication with a laser source and a spectrometer.

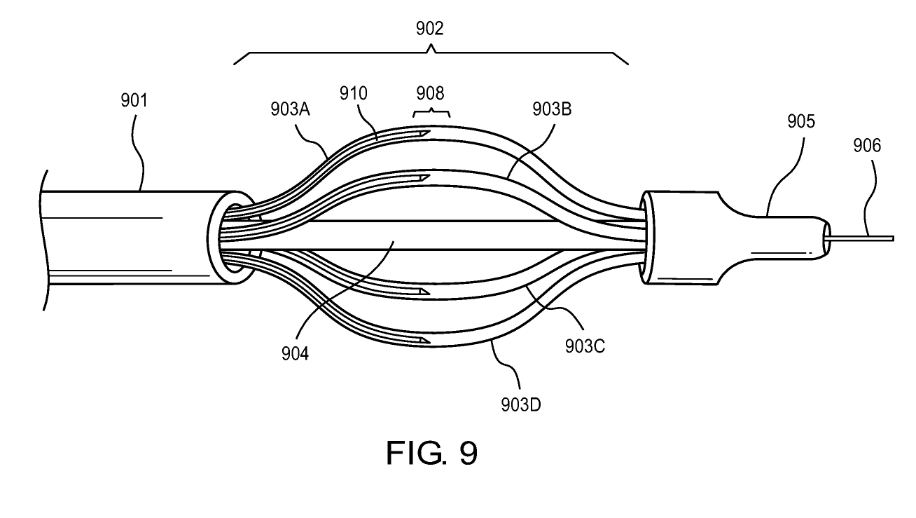

FIG. 9 shows a basket-style side viewing optical catheter that has four probe arms 903A-D in basket section 902 of the catheter. Each probe arm may include an optical probe assembly 910 according to the invention that terminates in or around the apex of the radially extended probe arm, i.e., defining a viewing portion 908, to contact or near a vessel wall so that a spectroscopic evaluation of the vessel wall can be performed. The probe arms may, for example, be composed of a polymer, such as a fluoropolymer, preferably a fluoropolymer lacking Carbon-Hydrogen (C—H) bonds, such as polychlorotrifluoroethylene (PCTFE) for use in Raman spectroscopic applications. The fluoropolymer may be an amorphous fluoropolymer, such as an amorphous fluoropolymer lacking C—H bonds. An optical window may be provided to permit light to transit from the optical fibers to and from a target if the material of the probe arm is insufficiently transparent or provides an undesirable level of interfering background. Windowless probe designs may also be used such as those disclosed in U.S. Publication No. 2008/0129993A1 (U.S. Ser. No. 11/876,899), which is incorporated by reference herein in its entirety. Each probe arm may also include a structural support element such as spring wire or durable polymer rod (not shown) to support the enclosed fiber optic probe. The catheter shown also includes a distal tip 905 that is connected to a guidewire tube 904, so that the catheter may travel over a guidewire 906, and to the distal end of each probe arm. The proximal end of each probe arm is attached to the proximal end of the basket section of the catheter at or near the distal end of main shaft 901 of the catheter. Radial expansion and contraction of the probe arms of the basket section may be accomplished by contracting and extending the opposite ends of the probe arms, respectively. The guidewire tube, which is attached to the distal tip of the catheter, may be slideable within the catheter thereby permitting said contracting and extending of the opposite ends of the probe with respect to each other. Optional radiopaque marker bands may also be disposed on the catheter to aid in visualizing the catheter within a blood vessel.

A related type of catheter that may be part of the systems of the invention for optically interrogating a blood vessel wall, includes: multiple optical probe rod elements (e.g., 2, 3, 4, 6, or 8) along a central shaft of the catheter and extendable radially outward toward a blood vessel wall from an unextended configuration closer to the longitudinal axis of the catheter and an expandable balloon collectively enclosing the multiple rod elements. The rod elements each include an optical assembly for transmitting and receiving light from the vessel wall lateral to the axis of the catheter while the rod elements contact or are near the wall. Each of the optical assemblies is directly or indirectly in optical communication a light source for illuminating the vessel wall and a detector (spectrometer) for detecting light received from the vessel wall. The optical assemblies of each rod element may be disposed at or around the middle of a rod element or at or around whatever part of a rod element tends to extend most radially outward. Relative motion of the distal ends and proximal ends of the rods may be used to radially flex the rods outward toward a lumen wall and to radially retract the rods toward the catheter axis.

Systems of the invention may include an intravascular catheter, for optically interrogating a blood vessel wall that includes: (1) a rod element portion near the distal end of the catheter comprising multiple rod elements along a central shaft of the catheter and extendable radially outward toward a blood vessel wall from an unextended configuration closer to the longitudinal axis of the catheter, wherein the rod elements each include an optical probe assembly according to the invention for transmitting and receiving light from the vessel wall lateral to the axis of the catheter while the rod-elements contact or are near the wall and wherein each of the optical assemblies is in optical communication with a light source for illuminating the vessel wall and a detector (spectrometer) for detecting light received from the vessel wall; and (2) a tip portion of the catheter that extends from the distal end of the rod element portion to the distal end of the catheter, wherein a guidewire conduit or channel extends from within the central shaft of the rod element portion of the catheter distally through the tip portion of the catheter. The guidewire channel or conduit may, for example, open within the rod element portion of the catheter and at or near the distal end of the tip portion of the catheter.

A related embodiment of the invention provides any of the above described systems further comprising a catheter, such as any of those described above, on/in which one or more fiber optic probes as described herein are disposed to permit optical interrogation within a body such as within a lumen of a body.

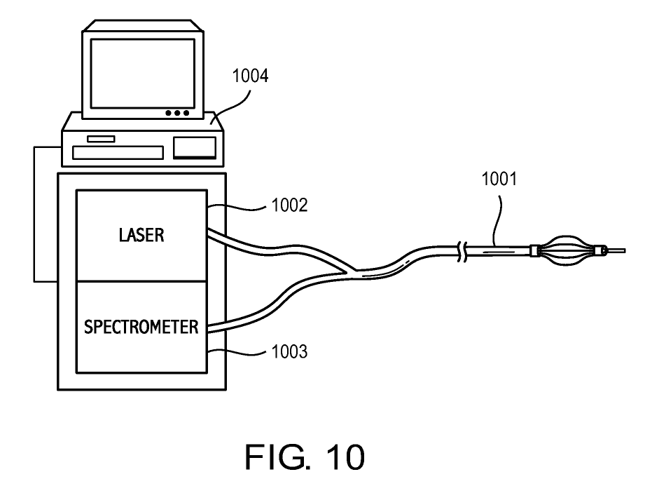

FIG. 10 illustrates a system embodiment of the invention that includes an intravascular basket style catheter 1001 (such as that shown in FIG. 7) which includes at least one optical probe as described herein, operably connected to a laser 1002, to provide illumination to a target via the delivery fiber(s), and a spectrometer 1003 to analyze light received from the collection fiber(s). The system further includes a computer 1004 operably connected to the laser and spectrometer, which computer controls the system and stores and/or analyzes data obtained from the spectrometer. As shown in the figure, the system also includes a display operably connected to computer 1004 and may also include an input device operably connected to the computer such as a keyboard (not shown).

Although the invention is exemplified in certain cases herein with respect to in vivo diagnostic applications, it should be understood that there is no limitation on the types of samples which may be analyzed using the probes, catheters and systems of the invention.

Each of the patents and other publications cited in this disclosure is incorporated by reference in its entirety.

Although the foregoing description is directed to the preferred embodiments of the invention, it is noted that other variations and modifications will be apparent to those skilled in the art, and may be made without departing from the spirit or scope of the invention. Moreover, features described in connection with one embodiment of the invention may be used in conjunction with other embodiments, even if not explicitly stated above.

1-27. (canceled)

28. A fiber optic probe, comprising:
a laser delivery optical fiber comprising a central axis, a proximal end and a distal end that comprises a distal face at least substantially normal to the central axis of the laser delivery optical fiber;
a light collection optical fiber comprising a central axis, a proximal end and a distal end that comprises a distal face that is normal or angled with respect to the central axis of the light collection optical fiber; and
an optical piece operably connected to the laser delivery optical fiber, the optical piece comprising a first face configured to receive laser light into the piece from the distal end of the laser delivery optical fiber, a second face adjacent to the first face and configured to reflect light from the laser delivery fiber in an off-axis direction toward and through the distal end of the light collection fiber to illuminate a sample, and a third face opposite the second face and configured to reflect light received back from the sample into the light collection optical fiber toward its proximal end,
wherein the distal face of the light collection optical fiber is angled with respect to its central axis and connected to the third face of the optical piece, or the distal face of the light collection fiber is normal with respect to its central axis and the probe further comprises an optical spacer between said distal face and the third face of the optical piece, and
wherein the central axes of the laser delivery optical fiber and the light collection optical fiber are at least substantially parallel to each other at the distal ends of the fibers.

29. The fiber optic probe of claim 28, wherein the distal face of the light collection optical fiber is angled at or about 45-degrees with respect to the central axis of the light collection optical fiber and is joined to the third face of the optical piece.

30. The fiber optic probe of claim 28, wherein:
the distal face of the light collection optical fiber is angled with respect to the central axis,
the first face of the optical piece is joined to the distal face of the laser delivery optical fiber,
the third face of the optical piece is joined to the distal face of the light collection optical fiber, and
the second and third face of the optical piece and the distal face of the optical collection fiber are at least substantially parallel to each other.

31. The fiber optic probe of claim 28, wherein:
the distal face of the light collection optical fiber is angled with respect to the central axis,
the first face of the optical piece is joined to the distal face of the laser delivery optical fiber,
the third face of the optical piece is joined to the distal face of the light collection optical fiber, and
the second and third face of the optical piece and the distal face of the optical collection fiber are at least substantially parallel to each other.

32. The fiber optic probe of claim 28, wherein:
the second face of the optical piece comprises a mirror or long wavelength pass filter.

33. The fiber optic probe of claim 32, wherein the third face of the optical piece comprises a short wavelength pass filter.

34. The fiber optic probe of claim 28, wherein the third face of the optical piece comprises a short wavelength pass filter.

35. The fiber optic probe of claim 28, wherein the optical piece has the profile of a parallelogram.

36. The fiber optic probe of claim 35, wherein the optical piece is a parallelepiped.

37. A fiber optic Raman spectroscopy probe, comprising:
a laser delivery optical fiber for delivering laser light comprising a central axis, a proximal end and a distal end that comprises a distal face at least substantially normal to the central axis of the laser delivery optical fiber;
a light collection optical fiber comprising a central axis, a proximal end and a distal end that comprises a distal face a distal face at least substantially normal to the central axis of the laser delivery optical fiber,
wherein the central axes of the laser delivery optical fiber and the light collection optical fiber are at least substantially parallel to each other at the distal ends of the fibers; and
a composite optical piece having a proximal surface facing the distal end faces of the optical fibers, said surface disposed at an angle with respect to the central axes of the optical fibers, the composite optical piece comprising
a proximal first filter layer within the optical field of the laser delivery fiber and the light collection fiber wherein the first filter layer is a short wavelength pass filter selected to transmit the laser light and reflect Raman scattered light received from a sample;
a distal second filter layer at least substantially restricted the optical field of the laser delivery fiber wherein the second filter layer is a long wavelength pass filter or mirror selected to reflect laser light from the laser delivery fiber.

38. The fiber optic probe of claim 37, wherein the proximal surface of the composite optical piece is disposed at or about a 45-degree angle with respect to the central axes of the optical fibers.

39. The fiber optic Raman spectroscopy probe of claim 37, further comprising an optical spacer disposed between the distal end faces of the optical fibers and the optical piece.

40. The fiber optic Raman spectroscopy probe of claim 37, wherein a short wavelength pass filter selected to reflect Raman scattered light arising from the light delivery optical fiber is disposed on the distal end of the laser delivery fiber.

41. The fiber optic Raman spectroscopy probe of claim 40, further comprising an optical spacer disposed between the distal end faces of the optical fibers and the optical piece.

42. A fiber optic Raman spectroscopy probe, comprising:
a laser delivery optical fiber for delivering laser light comprising a central axis, a proximal end and a distal end that comprises a distal face at least substantially normal to the central axis of the laser delivery optical fiber;
a light collection optical fiber comprising a central axis, a proximal end and a distal end that comprises a distal face a distal face at least substantially normal to the central axis of the laser delivery optical fiber,
wherein the central axes of the laser delivery optical fiber and the light collection optical fiber are at least substantially parallel to each other at the distal ends of the fibers; and
a composite optical piece having a proximal surface facing the distal end faces of the optical fibers, said surface disposed at or about a 45-degree angle with respect to the central axes of the optical fibers, the composite optical piece comprising:
a proximal first filter layer comprising:
a first section at least substantially restricted to the optical field of the laser delivery fiber, said first section being at least substantially transparent to the laser light, and
a second section at least substantially restricted to the optical collection filed of the light collection fiber, wherein said second section is a short wavelength pass filter selected to transmit the laser light and reflect Raman scattered light received from a sample, and
a distal second filter layer at least substantially restricted the optical field of the laser delivery fiber wherein the second filter layer is a long wavelength pass filter selected to reflect laser light from the laser delivery fiber and transmit Raman scattered light arising from the light delivery fiber.

43. The fiber optic Raman spectroscopy probe of claim 42, further comprising an optical spacer disposed between the distal end faces of the optical fibers and the composite optical piece.

44. A fiber optic probe, comprising:
a laser delivery optical fiber comprising a central axis, a proximal end and a distal end that comprises a distal face at least substantially normal or angled with respect to the central axis of the laser delivery optical fiber;
a light collection optical fiber comprising a central axis, a proximal end and a distal end that comprises a distal face that is normal with respect to the central axis of the light collection optical fiber; and
an optical piece operably connected to the light collection optical fiber, the optical piece comprising a first face joined to the distal end of the light collection fiber, a second face adjacent to the first face and configured to reflect light received into the optical piece from a sample toward and into the collection fiber, and a third face opposite the second face,
wherein the distal face of the laser delivery optical fiber is angled with respect to its central axis and connected to the third face of the optical piece, or the distal face of the laser delivery fiber is normal with respect to its central axis and the probe further comprises an optical spacer between said distal face and the third face of the optical piece, said spacer comprising an angled face connected to the third face of the optical piece, and
wherein the central axes of the laser delivery optical fiber and the light collection optical fiber are at least substantially parallel to each other at the distal ends of the fibers.

45. The probe of claim 44, wherein the second face of the optical piece comprises a mirror, a band-pass filter or a short-pass filter selected to reflect light received into the optical piece through its third face toward and into the light collection fiber.

46. The probe of claim 44, wherein the third face of the optical piece comprises a long pass filter selected to reflect laser light from the delivery fiber out of the probe to illuminate a sample while passing wavenumber-shifted light returning from the sample into the optical piece.

47. The probe of claim 44, wherein the angled face of the light delivery optical fiber or the optical spacer comprises a long pass filter selected to reflect laser light from the delivery fiber out of the probe to illuminate a sample while passing wavenumber-shifted light returning from the sample into the optical piece.

48. The fiber optic probe of claim 44, wherein the optical piece has the profile of a parallelogram.

49. The fiber optic probe of claim 48, wherein the optical piece is a parallelepiped.
